(19) United States
(12) Patent Application Publication
(10) Pub. No.: US 2012/0200984 A1
(43) Pub. Date: Aug. 9, 2012

(54) METHOD FOR MANUFACTURING A TIN/TA2O5/TIN CAPACITOR

(76) Inventor: Mickael GROS-JEAN, Grenoble (FR)

(21) Appl. No.: 13/359,831

(22) Filed: Jan. 27, 2012

(30) Foreign Application Priority Data
Feb. 4, 2011 (FR) 11/50922

(51) Int. Cl. H01G 4/06; H01G 7/00

(52) U.S. Cl. 361/311; 29/25.41

(57) ABSTRACT

A method for manufacturing a TiN/Ta₂O₅/TiN capacitor, including the steps of depositing, on a TiN layer, a Ta₂O₅ layer by a plasma enhanced atomic deposition method (PEALD), within a temperature range from 200 to 250° C., by repeating the successive steps of:

depositing a tantalum layer from a precursor at a partial pressure ranging between 0.05 and 10 Pa; and

applying an oxygen plasma at an oxygen pressure ranging between 1 and 2000 Pa.

### CROSS REFERENCE TO RELATED APPLICATION

This application is a translation of and claims the priority benefit of French patent application number 11/50922 filed on Feb. 4, 2011 entitled “Method for manufacturing a TiN/Ta₂O₅/TiN capacitor” which is hereby incorporated by reference to the maximum extent allowable by law.

### BACKGROUND OF THE INVENTION

1. Field of the Invention

The present invention relates to the manufacturing of MIM (Metal-Insulator-Metal) capacitors, and more specifically of TiN/Ta₂O₅/TiN capacitors. The present invention also relates to a TiN/Ta₂O₅/TiN capacitor.

2. Discussion of Prior Art

TiN/Ta₂O₅/TiN-type capacitors have developed over the last years, especially on account of their compatibility with the manufacturing of the metallization levels of an integrated circuit and because, due to the high dielectric constant of Ta₂O₅, they can have high capacitances for small surface areas. Such capacitors are for example used to form the capacitors of DRAM-type memory cells, of radio frequency filters, or of analog-to-digital converters.

Among methods for forming such capacitors, a plasma enhanced atomic layer deposition method has been provided to form the tantalum pentoxide Ta₂O₅ layer, this method being currently designated as PEALD (plasma enhanced atomic deposition method).

This method comprises alternating phases of tantalum deposition from a precursor, for example, the so-called TBTDET product, that is, tertbutylimido-tris-diethylamino tantalum, and phases of application of an oxygen plasma. Then, an upper TiN electrode is deposited by any adapted method.

Among the qualities which are expected from a capacitor, it is especially desired for it to have as low a leakage current as possible, preferably lower than 10⁻⁷ A/cm². The dielectric relaxation factor is also desired to be minimized. This relaxation factor, FR, characterizes the capacitance variation of a capacitor according to frequency and is defined by relation FR=[C(1 kHz)−C(10 kHz)]/C. Thus, this factor characterizes the capacitance variation of a capacitor between an operation at a 1-kilohertz frequency and an operation at a 10-kilohertz frequency. Physically, this factor is linked to the presence of dipoles in the dielectric and to the relaxation time of these dipoles.

Various standards set the desired values of the relaxation factor. Current standards impose for this relaxation factor to be, in percent, smaller than 0.2 for a capacitor operation at 25° C. and smaller than 0.6 for a capacitor operation at 125° C.

In practice, existing TiN/Ta₂O₅/TiN capacitors generally have insufficient characteristics in terms of leakage current and of dielectric relaxation factor.

Thus, there is a need to improve such capacitors.

### SUMMARY OF THE INVENTION

An embodiment provides a method for manufacturing TiN/Ta₂O₅/TiN capacitors which have optimized leakage current and dielectric relaxation factor characteristics.

Another embodiment provides a capacitor having such optimized characteristics.

Thus, an embodiment provides a method for manufacturing a TiN/Ta₂O₅/TiN capacitor, comprising depositing, on a TiN layer, a Ta₂O₅ layer by a plasma enhanced atomic deposition method (PEALD), within a temperature range from 200 to 250° C., by repeating the successive steps of:

depositing a tantalum layer from a precursor at a partial pressure ranging between 0.05 and 10 Pa; and

applying an oxygen plasma at an oxygen pressure ranging between 1 and 2,000 Pa.

According to an embodiment, the tantalum precursor is TBTDET.

According to an embodiment, the partial TBTDET pressure ranges from 0.5 to 2 Pa.

According to an embodiment, the partial TBTDET pressure is equal to 1 Pa to within 10%.

According to an embodiment, the partial oxygen pressure during plasma phases ranges from 10 to 30 Pa.

According to an embodiment, the partial oxygen pressure during plasma phases is equal to 25 Pa to within 10%.

An embodiment provides a TiN/Ta₂O₅/TiN capacitor wherein the interface layer between TiN and Ta₂O₅, on the side where the Ta₂O₅ has been made to grow, comprises an interface region between TiN and Ta₂O₅ having a thickness smaller than or equal to 2 nm.

The foregoing and other features, and embodiments will be discussed in detail in the following non-limiting description of specific embodiments in connection with the accompanying drawings.

### BRIEF DESCRIPTION OF THE DRAWINGS

FIG. 1 shows two curves of the leakage current versus the electric field applied to the dielectric of a TiN/Ta₂O₅/TiN capacitor;

FIGS. 2A and 2B show the shape of two curves illustrating the dielectric relaxation factor of a TiN/Ta₂O₅/TiN capacitor;

FIGS. 3A and 3B show the variation of the growth rate of a Ta₂O₅ layer deposited by PEALD; and

FIG. 4 shows a capacitor according to an embodiment.

FIG. 5 is a flow chart according to an embodiment.

### DETAILED DESCRIPTION

The applicant has analyzed the behavior of tantalum nitride as a dielectric. There appears that, to form a proper dielectric, tantalum oxide must be deposited in an even layer, the degree of oxidation of tantalum must be equal to 5, and the material must contain a minimum amount of oxygen vacancies.

Up to now, to obtain this result, it has been aimed at forming the Ta₂O₅ layer in as oxidizing conditions as possible. The applicant has observed that this is actually disadvantageous and tends to oxidize the underlying TiN layer and to form an interface area containing various compounds of Ti, O, N, and Ta, and that the presence of this interface area adversely affects the characteristics of the obtained capacitor. Thus, the applicant has searched for PEALD Ta₂O₅ forming conditions which avoid the forming of this area at the interface between TiN and Ta₂O₅. More specifically, the applicant aims at forming a Ta₂O₅ layer on TiN such that the interface area has a thickness lower than 2 nm.

To achieve this result, the applicant provides:
all along the PEALD process, limiting the temperature with a range from 200 to 250° C.,
during the steps of tantalum deposition from TBTDET, limiting the partial pressure of TBTDET within a range from 0.05 to 10 Pa, preferably from 0.5 to 2 Pa, preferably on the order of 1 Pa to within 10%, and
during phases of application of an oxygen plasma, limiting the partial oxygen pressure within a range from 1 to 2,000 Pa, preferably from 10 to 30 Pa, preferably 25 Pa to within 10%.

The applicant has shown that this choice provides optimized results in terms of leakage current and of dielectric relaxation factor.

The curves of FIG. 1 shows the shape of the leakage current density in amperes per cm² according to the applied field in MV/cm, that is, a value 1 of the field corresponds to a 1-volt voltage across a dielectric layer of 10-nm thickness (or to a 5-volt voltage across a 50-nm layer). Curve 10 corresponds to a 350° C. deposition temperature and to a partial oxygen pressure on the order of 400 Pa during plasma phases and curve 12 corresponds to a 200° C. processing temperature and to a partial oxygen pressure on the order of 25 Pa during plasma phases. It can be observed that leakage currents are much lower in the case of curve 12. This provides a general indication as to the fact that decreasing the processing temperature and the oxygen pressure during plasma phases to minimize leakage currents is advantageous.

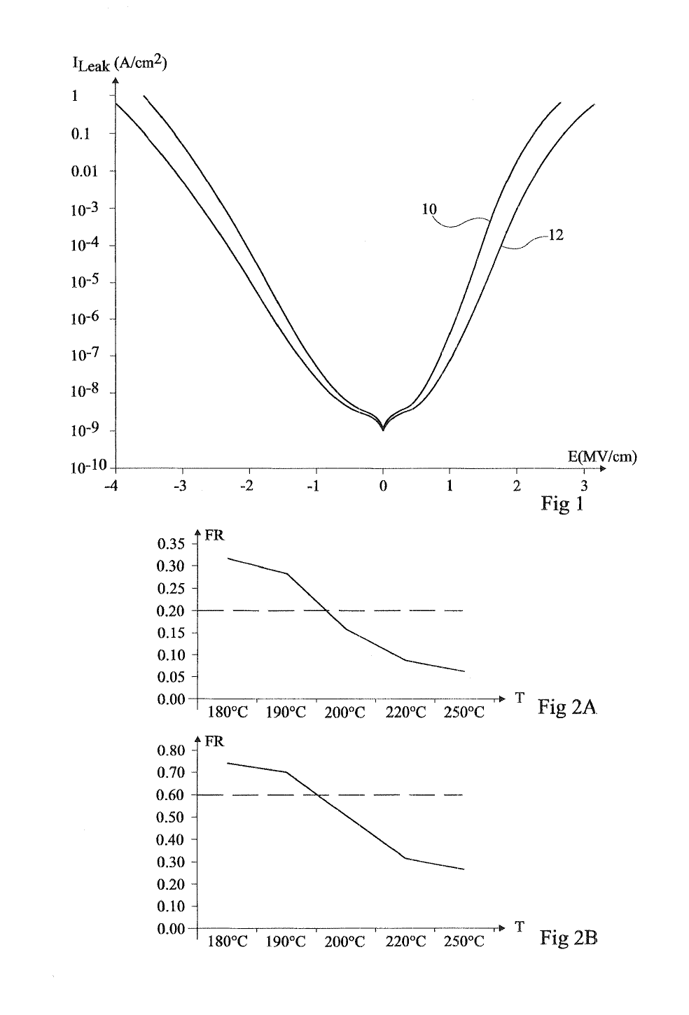

The curves of FIGS. 2A and 2B illustrate the value of relaxation factor FR in percents according to the processing temperature, for respective capacitor operating temperatures of 25° C. and 125° C. These curves show that it is better not to excessively decrease the temperature, especially not to decrease it below a 200° C. temperature if a value of the relaxation factor smaller than the targeted standard, of 0.2% at 25° C. and of 0.6% at 125° C., is desired to be maintained.

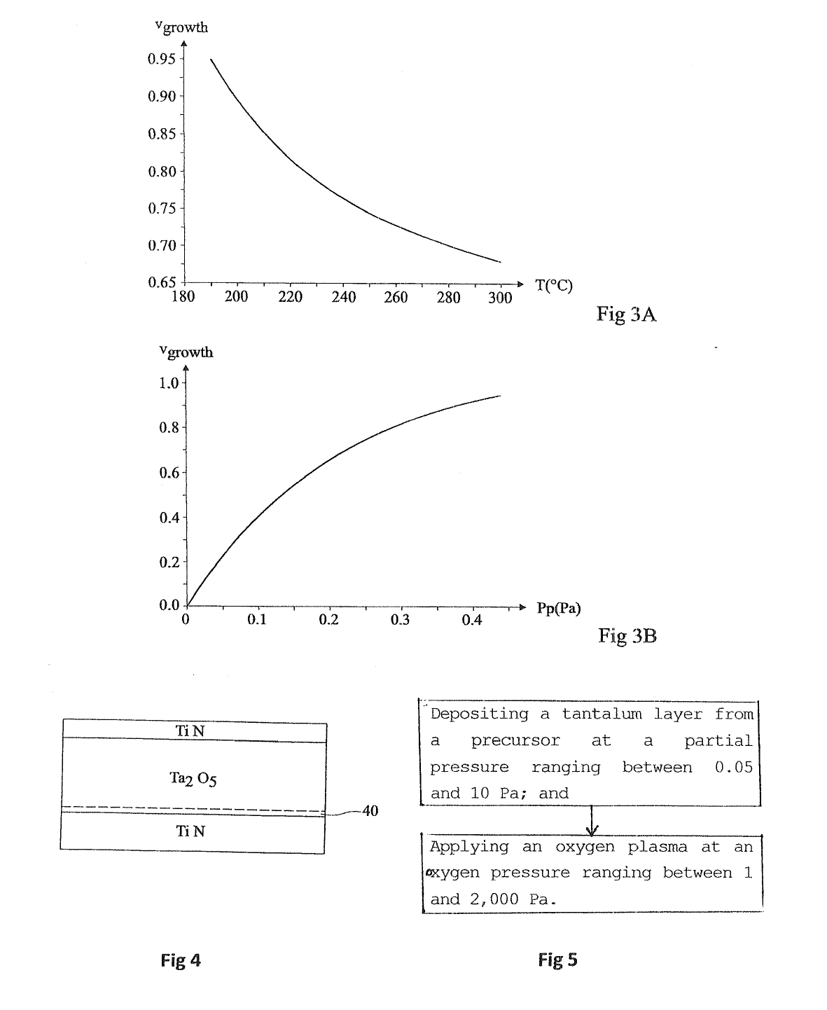

FIG. 3A shows the variation of the Ta₂O₅ layer deposition rate according to temperature. It can be seen that to increase this rate, the temperature should advantageously be decreased below a 250° C. value. FIG. 3B illustrates the variation of the Ta₂O₅ layer deposition rate according to the partial pressure of the precursor (TBTDET). It can be seen that if a proper growth rate is desired to be maintained, a partial pressure greater than 0.2 Pa is preferable.

All these constraints, that is, obtaining a low leakage current, obtaining a low relaxation factor, obtaining a proper growth rate, lead to selecting the previously indicated values.

Further, the applicant has cut through capacitors obtained in various manufacturing conditions. What appears is that, for capacitors having satisfactory characteristics, the area at the interface between TiN and Ta₂O₅ designated with reference 40 in FIG. 4 has a thickness smaller than or equal to 2 nm. Prior art capacitors having less satisfactory characteristics appear to have interface areas (mixed Ti—O—N—Ta area) of a much larger thickness, currently on the order of 3 nm or more.

Thus, as described hereinabove and illustrated in FIG. 5, applicant has disclosed a method for manufacturing a TiN/Ta₂O₅/TiN capacitor, comprising depositing, on a TiN layer, a Ta₂O₅ layer by a plasma enhanced atomic deposition method (PEALD), within a temperature range from 200 to 250° C., by repeating the successive steps of:

depositing a tantalum layer from a precursor at a partial pressure ranging between 0.05 and 10 Pa; and

applying an oxygen plasma at an oxygen pressure ranging between 1 and 2,000 Pa.

Of course, the present invention is likely to have various alterations, modifications, and improvements which will occur to those skilled in the art. In particular, the various PEALD deposition variations may be used, within the limits indicated hereabove.

Further, the durations of the phases of tantalum precursor deposition and of application of an oxidizing plasma may vary within a range from 50 ms to 5 s, preferably between 100 and 500 ms.

Further, complementary processings known in the art may be used, especially to deposit the upper TiN layer. Moreover, oxidizing anneals of the obtained structure may also be performed before deposition of the final TiN layer to optimize the capacitor characteristics. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for manufacturing a TiN/Ta₂O₅/TiN capacitor, comprising depositing, on a TiN layer, a Ta₂O₅ layer by a plasma enhanced atomic deposition method (PEALD), within a temperature range from 200 to 250° C., by repeating the successive steps of:
depositing a tantalum layer from a precursor at a partial pressure ranging between 0.05 and 10 Pa; and
applying an oxygen plasma at an oxygen pressure ranging between 1 and 2,000 Pa.

2. The method of claim 1, wherein the tantalum precursor is tertbutylimido-tris-diethylamino tantalum (TBTDET).

3. The method of claim 2, wherein the partial TBTDET pressure ranges from 0.5 to 2 Pa.

4. The method of claim 3, wherein the partial TBTDET pressure is equal to 1 Pa to within 10%.

5. The method of claim 1, wherein the partial oxygen pressure during plasma phases ranges from 10 to 30 Pa.

6. The method of claim 5, wherein the partial oxygen pressure during plasma phases is equal to 25 Pa to within 10%.

7. A TiN/Ta₂O₅/TiN capacitor, wherein the interface layer between TiN and Ta₂O₅, on the side where the Ta₂O₅ has been made to grow, comprises an interface region between TiN and Ta₂O₅ having a thickness smaller than or equal to 2 nm.
